(19) United States
(12) Patent Application Publication
(10) Pub. No.: US 2026/0230454 A1
(43) Pub. Date: Aug. 6, 2026

(54) MULTICLOUD GATEWAY WITH INLINE NATURAL LANGUAGE PROMPT INSPECTION

(71) Applicant: Cisco Technology, Inc., San Jose, CA (US)

(72) Inventors: Vijay Chander, San Ramon, CA (US); Sunil Kumar, San Jose, CA (US); Praveen Kumar Patnala, Santa Clara, CA (US); Vishal Jain, Los Gatos, CA (US)

(21) Appl. No.: 19/245,089

(22) Filed: Jun. 20, 2025

Related U.S. Application Data
(60) Provisional application No. 63/755,047, filed on Feb. 6, 2025.

(51) Int. Cl. H04L 9/40

(52) U.S. Cl. CPC H04L 63/0428; H04L 63/1416; H04L 63/166

(57) ABSTRACT

Disclosed are systems, apparatuses, processes, and computer-readable media for multicloud gateway with inline natural language prompt inspection. For example, a disclosed method includes decrypting, at a gateway of a multicloud defense system, an application stream from a plurality of packets; inspecting a request or a response in the application stream for natural language content in a payload of the request or the response; requesting, by the gateway of the multicloud defense system, authorization from a defense system to send the natural language content to a destination address; and providing, to the destination address, the plurality of packets based on the authorization from the defense system.

### CROSS REFERENCE TO RELATED APPLICATIONS

This application claims priority to U.S. Patent Application No. 63/755,047, filed Feb. 6, 2025, entitled “MULTICLOUD GATEWAY WITH INLINE NATURAL PROMPT INSPECTION” which is incorporated by reference herein in its entirety.

### TECHNICAL FIELD

The disclosure relates generally to network security, and more specifically a

### BACKGROUND

Network security is a critical aspect of modern digital infrastructure, ensuring that data, applications, and systems remain protected from unauthorized access, cyber threats, and malicious activities. Traditionally, network security relied on perimeter-based defenses like firewalls and intrusion detection systems. However, as networks evolved with cloud computing, microservices, and zero-trust architectures, security approaches shifted towards inline threat detection, where malicious activities are identified and mitigated in real-time as traffic flows through the network. Deep Packet Inspection (DPI) and Intrusion Prevention Systems (IPS) are commonly used techniques to identify malware, command-and-control traffic, and policy violations. Additionally, cloud security platforms provide inline threat intelligence, leveraging global threat databases to detect and prevent cyberattacks dynamically. The ability to identify threats inline allows organizations to respond in real-time, enforce security policies proactively, and prevent data breaches before they escalate into significant incidents.

Another important aspect is data loss prevention (DLP) to prevent unauthorized access, transfer, or leakage of sensitive information. Organizations use DLP solutions to detect, monitor, and control data movement across networks, endpoints, and cloud environments, ensuring compliance with regulations like General Data Protection Regulation (GDPR), Health Insurance Portability and Accountability Act (HIPAA), and California Consumer Privacy Act (CCPA). DLP also addresses data exfiltration and attempts to steal sensitive data by bypassing security controls. Data exfiltration can occur through various channels, including phishing attacks, malware, misconfigured cloud storage, external storage devices, encrypted tunnels, or covert domain name server (DNS) traffic.

### BRIEF DESCRIPTION OF THE DRAWINGS

Illustrative embodiments of the present application are described in detail below with reference to the following drawing figures:

FIG. 1 is a conceptual block diagram of an artificial intelligence (AI) defense controller system in accordance with some aspects of the disclosure;

FIG. 2 is a conceptual diagram of an inspection path of the AI defense controller system for ingress and egress traffic in accordance with some aspects of the disclosure;

FIG. 3 is a block diagram illustrating a hardware accelerator that can be configured to offload various operations associated with a datacenter in accordance with some aspects of the disclosure;

FIG. 4 is a sequence diagram of a multicloud gateway for inline natural language prompt and answer inspection in accordance with some aspects of the disclosure;

FIG. 5 is a conceptual illustration of a TLS session termination for inline packet inspection by a hardware accelerator in accordance with some aspects of the disclosure;

FIG. 6 is a flowchart illustrating an example process for inline natural language prompt and answer inspection by a gateway of a multicloud system in accordance with some aspects of the disclosure;

FIG. 7 illustrates a block diagram of a data path pipeline and integration with hardware in accordance with some aspects of the disclosure; and

FIG. 8 is a diagram illustrating an example of a system for implementing certain aspects of the present technology.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

### EXAMPLE EMBODIMENTS

Examples are described herein in the context of an multicloud gateway with inline natural language prompt inspection. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

Machine learning, AI, and neural networks have evolved due to advances in deep learning, generative AI, and large-scale computing power. Transformer architectures, such as generative pretrained transformer (GPT) and bidirectional encoder representations (BERT) enable more human-like text generation, summarization, and reasoning and allow natural language conversations with machines. These models often are employed for natural language functions such as conversion of unstructured, human-readable text into more structured data for various purposes. Other advances include diffusion models with enhanced generative AI to create images, videos, and music audio.

The models that drive services for AI-based functions are not easily deployed on local resources because the models require parallelization of computations, generally with tensor processing units (TPUs), graphics processing units (GPUs), and other neural processing units (e.g., neural engines, neural network processing units (NNPUs), etc.). These services are primarily cloud-native and require the transmission of natural language prompts and corresponding answers to those prompts across the network. The custom training of these models may also require the transmission of significant volumes of data to cause further training or adapters to learn new information within a specialized domain of knowledge.

Conventional network security is typically deployed using firewalls, intrusion detection, and prevention systems, virtual private networks (VPNs), data loss prevention (DLP), and endpoint security tools that rely on signature-based detection, rule-based policies, and manual configurations to identify threats. Network security is analyzed by monitoring traffic patterns, blocking known malicious signatures, and enforcing predefined access controls to protect networks and devices. Modern, AI-powered cyber threats can adapt to and evade signature-based detection, exploit zero-day vulnerabilities, and extract sensitive information from protected networks.

Cloud-based applications and workloads are distributed across heterogeneous solutions (e.g., different cloud providers) and have different underlying services that operate with different variations, such as keys, endpoints, and other information. A multicloud defense system (MCD) is configured to abstract all of the variations across a cohesive platform to simplify the security of multicloud deployed applications by providing gateways that enforce policies for customers.

Disclosed are systems, apparatuses, methods, computer readable medium, and circuits for a multi-cloud gateway with inline natural language prompt inspection. According to at least one example, a method includes: decrypting, at a gateway of a multicloud defense system, an application stream from a plurality of packets; inspecting a request or a response in the application stream for natural language content in a payload of the request or the response; requesting, by the gateway of the multicloud defense system, authorization from a defense system to send the natural language content to a destination address; and providing, to the destination address, responses based on the authorization (e.g., permission) from the defense system. In some aspects, the multi-cloud gateway is configured to accumulate requests or responses in the packets, which are sent to an AI defense system with guardrails and an API Key. For example, the guardrails can be a configured based on aspects of the requests or responses. The AI defense system returns an verdict of the permission (e.g., deny, permit, or log) for the requests or responses to permit sending the requests or response to a corresponding device.

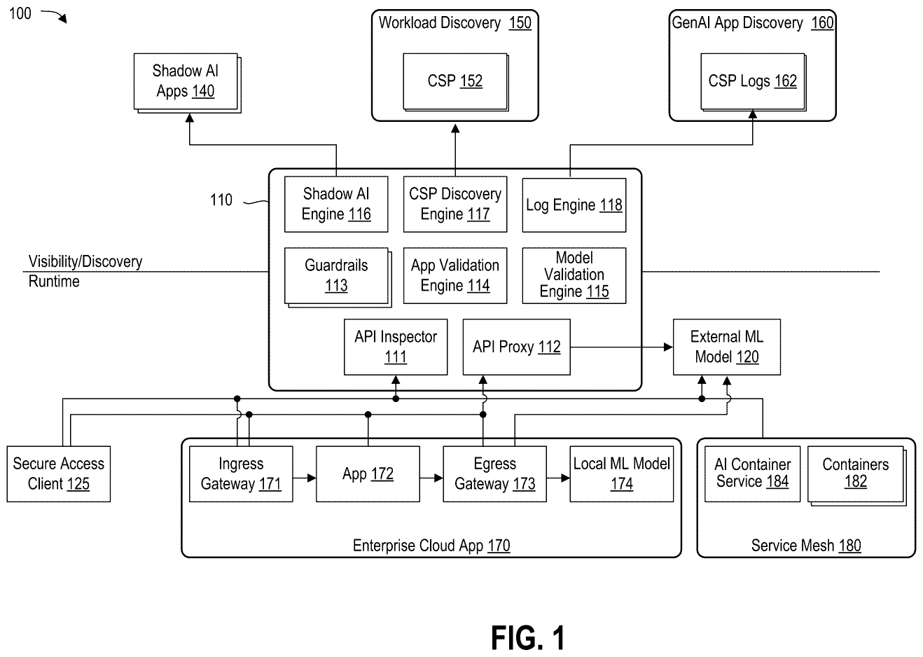

FIG. 1 is a conceptual block diagram of an AI defense system 100 in accordance with some aspects of the disclosure. In some aspects, the AI defense system 100 includes an AI defense controller 110 that is configured to transparently and securely inspect ingress and egress information to and from various machine learning (ML) and AI-based services. In some aspects, ML and AI herein may be used interchangeably to indicate non-deterministic processes performed by ML models including neural networks to apply learning based on various types of training. ML models (or AI models) can be relatively simple models (e.g., thousands of parameters such as a classifier) that can operate at line speed or can be large language models (LLMs) that have billions of parameters that require complex calculations to infer based on previous learning.

The AI defense controller 110 includes an application programming interface (API) inspector 111 and an API proxy 112 that interface with various components of an enterprise network. The AI defense controller 110 also includes at least one guardrail 113, which is a set of rules to invoke to ascertain the safety of a request or response, identify potential data leakage, and so forth. In some aspects, the AI defense controller 110 also includes an application validation engine 114, a model validation engine 115, a shadow AI engine 116, a cloud service provider (CSP) discovery engine 117, and a log engine 118.

In some aspects, the AI defense controller 110 is configured to operate a runtime to handle network requests to perform various network security functions. For example, the API inspector 111 is configured to perform API request inspection by analyzing API requests for security threats, anomalies, and compliance issues without altering network flow. In some aspects, a secure access client 125 (e.g., a VPN user connected to an enterprise network) may send an API request to the API inspector 111 to determine if the network user is permitted to access a particular destination address. The API inspector 111 may receive the request, which can include headers, and a body, and execute one or more guardrails 113 to determine whether to allow or block the request. In some aspects, the AI defense controller 110 may also include an API proxy 112 to proxy network requests to manage, modify, and secure API requests between clients and backend services.

In some aspects, the guardrails 113 are sets of rules, heuristics, or models that are configured to analyze network requests of the AI defense controller 110. For example, a guardrail 113 can include conventional heuristic rules to allow/deny traffic, such as by rate-limiting input or output from an ML model. In some aspects, a guardrail 113 may also be an ML model that classifies network data into various types of classifications, such as safe/not safe, malicious activity type, benign activity type, and so forth. For example, a guardrail 113 can be configured to identify code execution requests, which may be strictly forbidden, or a cross-site script (XSS) injection request, and so forth. The guardrail 113 can include a shallow path for an initial assessment of the contents of the packet and a deep path for a detailed assessment of the contents of the packet. For example, the shallow path can be performed on every packet and, when a packet is identified as potentially suspicious based on the guardrail 113, a deep path inspection can be invoked.

In some aspects, the AI defense controller 110 also includes a visibility/discovery phase for identifying assets and assessing those assets. The visibility/discovery phase includes an application validation engine 114 that is configured to assess application security posture. In some aspects, the application validation engine 114 is configured to inject a known repository of exploits and other malicious actions to determine if the application provides undesirable responses, indicating that the application is subject to potential exploits. In some aspects, application validation engine 114 can be integrated into a third-party platform to receive continuous updates to test internal or external applications. For example, native applications can be configured with a webview framework (e.g., Electron) that uses an HTML renderer for rendering the application, and the application validation engine 114 may test various injection techniques (e.g., XSS, cascading style sheet (CSS) injections using pseudo-selectors such as: has( ), etc.).

The AI defense controller 110 can also include a model validation engine 115 configured to inject a known repository of exploits and other malicious actions to determine if an ML model provides undesirable responses, indicating that the model is subject to potential exploits. Similar to the application validation engine 114, the model validation engine 115 can be integrated into a third-party platform to receive continuous updates to test internal or external models.

The application validation engine 114 and the model validation engine 115 are continually evolving to add new threats and malicious acts and provide a significant volume of information that can be used to identify weaknesses and other potential attack vectors. In some cases, the responses from targets of the application validation engine 114 and the model validation engine 115 can be used to generate a repository of information and identify characteristics representative of attacks on models and applications. In turn, the AI defense controller 110 can use the characteristics representative of attacks to continually adapt the guardrail 113 to identify malicious acts and data exfiltration attempts.

The shadow AI engine 116 is configured to detect unsanctioned usage of one at least one shadow AI application 140 and record data pertaining to usage of that shadow AI application 140. In some aspects, a shadow AI application 140 is an unsanctioned model that is being used and can be accessed through an interface. For example, CSPs can enable access to an ML service (e.g., OpenAI, Anthropic, etc.) via a gateway that handles certain traffic mechanisms (e.g., retry mechanisms such as circuit breakers) and ensure correct service, such as a streaming response. In some aspects, the shadow AI engine 116 is configured to identify usage of the shadow AI application 140 and records information pertaining to its usage, such as recording headers, payloads, and responses. In some cases, the shadow AI engine 116 may detect a request to an unauthorized domain and redirect usage through an unsupported interface (e.g., the CSP gateway) to allow the shadow AI engine 116 to record information pertaining to the usage of the model.

In some aspects, the shadow AI engine 116 is also configured to detect the usage of a model by other applications. In many cases, current applications are employing API access to ML services to reduce heavy data entry, improve authentication, and provide enhanced user experiences. For example, the shadow AI engine 116 can detect when such applications are employing indirect access to ML models based on signatures in responses, or natural language in network requests.

In some aspects, the AI defense controller 110 includes a workload discovery service 150 using a CSP discovery engine 117. In some aspects, the CSP discovery engine 117 is configured to connect to one or more CSPs 152 to inspect for services, models, agents, and workloads that are available to the AI defense controller 110. The CSP discovery engine 117 identifies allocated virtual private cloud (VPC) instances and allows the AI defense controller 110 to dynamically build a repository of applications and services that are exposed to the AI defense controller 110 without requiring explicit configuration. The CSP discovery engine employs a combination of heuristics and models to identify various endpoints and models.

The AI defense controller 110 also includes a log engine 118 to implement a generative AI application discovery service 160 that connects to the various CSPs and identifies ML-based usage. For example, the log engine 118 is configured to access CSP logs and inspect the CSP logs 162 for generative AI application usage. For example, the log engine 118 may access domain name server (DNS) logs, access logs, flow logs, model logs, and so forth. In some aspects, the various logs can surface information that can be analyzed for natural language queries and corresponding responses to the natural language queries.

The AI defense controller 110 can be integrated at multiple levels to provide a holistic view of the usage of AI and ML-based functions and defensive coordination at different levels of abstraction. For example, the secure access client 125 (e.g., a VPN user) can request the API inspector 111 for permission to access an external ML model 120 or API proxy 112 to proxy the request to the external ML model 120.

The AI defense controller 110 can also be integrated into an enterprise cloud application 170 that is configured in heterogeneous CSP services. The enterprise cloud application 170 may be integrated into a multi-cloud defense system that includes an ingress gateway 171 that is transparent and provides various security mechanisms, such as distributing consistent firewall configuration from a centralized control system (not shown). For example, the ingress gateway 171 may also include a web application firewall (WAF) configured for stateful inspection of requests and responses to an application 172. The ingress gateway 171 can also request a safety inspection of a request from the AI defense controller 110 using the guardrail 113.

The enterprise cloud application 170 may include an application 172 including generative AI features as part of an external ML model 120 or a local ML model 174 within the enterprise cloud application 170. For example, the external ML model 120 can be a fine-tuned trained version of an ML model service (e.g., OpenAI, Anthropic, etc.) to provide public enterprise information to consumers of the application 172. Models can be trained to provide chatbot functions to assist customers in identifying products and services. In another example, external models can be trained based on real-time functions to provide voice interactivity for customer support functions, and so forth.

In some aspects, an egress gateway 173 can perform a stateful inspection of the requests from the application 172 to the external ML model 120 or the local ML model 174 to ensure that the prompts and information returned from the external ML model 120 or the local ML model 174 are safe and aligned with business purposes. In some cases, prompts can include malicious instructions to attempt to cause the external ML model 120 or the local ML model 174 to reveal proprietary information. The AI defense controller 110 identifies these malicious instructions and answers to those prompts to prevent unauthorized access to sensitive information. In some aspects, the AI defense controller 110 can also include guardrails 113 for training these models to ensure that proprietary information and personally identifiable information do not touch these models during fine-tuning.

In some aspects, the AI defense controller 110 can be integrated into a service mesh 180 that is executed in various data centers. For example, the various services can be distributed across a plurality of containers 182 (e.g., Kubernetes) and a container service 184 that provides networking, observability, and security for container-based workloads. For example, the container service 184 may use an extended Berkeley Packet Filter (eBPF) to perform proxy, load balancing, authentication, and observability functions such as enforcing policies, performing deep packet inspection, and applying security rules to application traffic. The container service 184 can be integrated into the AI defense controller 110 to allow stateful AI defense such as denying and allowing traffic based on AI policies.

The AI defense controller 110 provides multiple integration points to allow stateful inspection of prompts and answers to those prompts. In some aspects, the AI defense controller 110 is configured to inspect prompts (e.g., in HTTP requests) to identify the safety of the prompts and inspect answers to those prompts, and identify the safety of the answers. The answers are a stream of data (e.g., a stream of HTTP responses) to allow inference operation to provide partial data based on the time-based nature of inference. The AI defense controller 110 is configured to analyze the answer as the responses are being received to make a determination regarding the safety of the response. In some cases, the AI defense controller 110 can analyze the prompt and the response to determine the safety of the prompt and the response together.

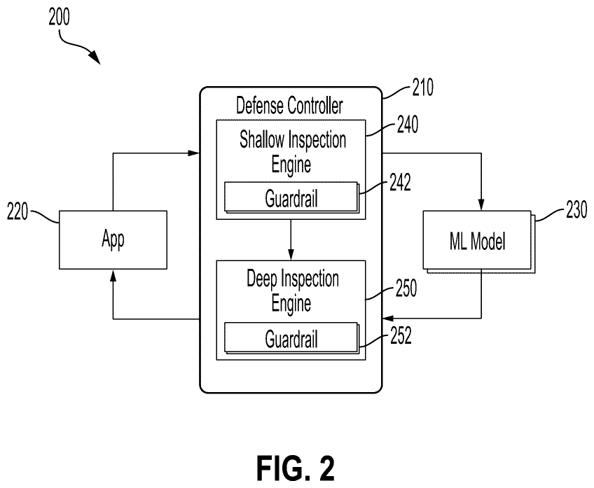

FIG. 2 is a conceptual diagram 200 of an inspection path of the AI defense controller system for ingress and egress traffic in accordance with some aspects of the disclosure. In some aspects, the controller 210 is configured to receive prompts from an application 220 that uses an ML model 230 (e.g., the external ML model 120 or the local ML model 174) for various operations. The application 220 can be a browser-based application (e.g., a front-end JavaScript bundle for rendering a UI) or a native application that uses a network connection to access the ML model 230.

The application 220 is configured to send a request including a prompt to the defense controller 210 transparently. For example, the secure access client 125 in FIG. 1 may request permission to send the request from an API inspector (e.g., the API proxy 112) or may send the request to an API proxy (e.g., the API proxy 112 in FIG. 1).

The defense controller 210 includes a shallow inspection engine 240 that is configured to analyze the request using one or more guardrails 242. For example, the guardrails include a combination of heuristic and model-based functions that are trained to identify safety. In one example, the guardrails may be configured to identify signatures that represent patterns associated with safe and unsafe prompts. The guardrails 242 renders a safety verdict to determine whether the prompt is safe or whether a detailed analysis of the prompt should be performed.

In some aspects, when the guardrails 242 identify potentially unsafe or malicious prompts, a deep inspection engine 250 is invoked to use one or more guardrails 252. In some aspects, the guardrails 252 of the deep inspection engine 250 provide a comprehensive review of the prompt to ensure that the shallow inspection engine 240 does not provide a false positive. For example, the deep inspection engine 250 may include a large language model or a reasoning ML model that can identify a reason that a particular prompt was denied, such as an attempt to retrieve an external node and injected that code into a prompt or a response. To the extent the deep inspection engine 250 identifies a malicious prompt, the deep inspection engine 250 may deny transmission of the prompt and record information pertaining to the prompt. To the extent that the deep inspection engine 250 identifies a potentially malicious prompt, the deep inspection engine 250 may log the prompt for subsequent analysis and permit the prompt, subject to additional inspection of the response. In some cases, malicious prompts can be converted into probes or test cases to allow components of the defense controller 210 (e.g., the application validation engine 114 and the model validation engine 115) to probe services, applications, and models.

The ML model 230 may provide a response including a portion of an answer to permitted prompts. The defense controller 210 is configured to inspect the answer using the shallow inspection engine 240 and the deep inspection engine 250 similar to the prompt. In some aspects, the inspection of the answer from the ML model 230 may be stateful and ensure that the prompt and the answer are sufficiently related. For example, an answer generally incorporates features of a prompt, and failure to incorporate any feature may be an indication of hijacking of the prompt or bootstrapping of other information into the prompt to generate an unsafe or malicious response.

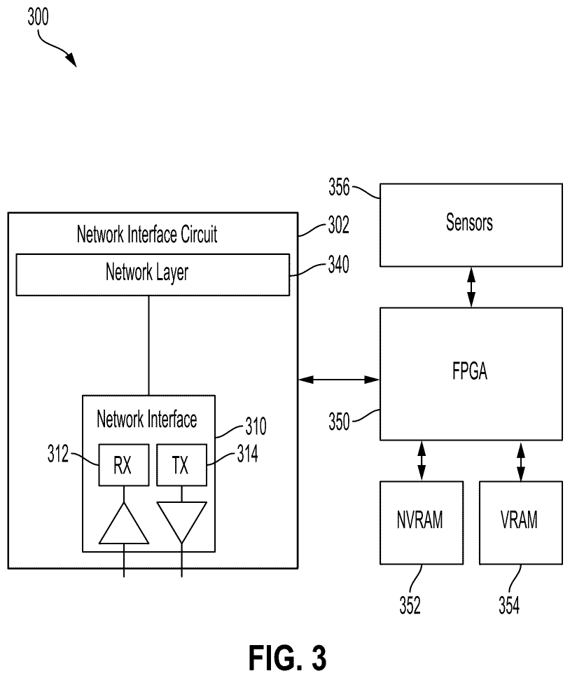

FIG. 3 is a block diagram illustrating a hardware accelerator 300 that can be configured to offload various operations associated with a datacenter in accordance with some aspects of the disclosure. The hardware accelerator 300 includes a network interface circuit 302 that is configured to interface with the first network interface 310. The network interface circuit 302 also a network layer 340 for processing packets. The first network interface 310 is connected to a first network (e.g., the first nodes) and includes a receive circuit 312 and a transmit circuit 314 for providing access to the physical interface.

The network interface circuit 302 is connected to a programmable hardware such as an FPGA 350. In some aspects, the hardware accelerator 300 is directly connected to the FPGA to reduce control operations of other devices. In some architectures, the FPGA 350 and the network interface circuit 302 may be connected directly via high-speed serial links such as Quad Small Form-factor Pluggable (QSFP) or a direct bus connection such as Peripheral Component Interconnect Express (PCIe) to allow direct data transfer.

In some aspects, the FPGA 350 may also be connected to a non-volatile random access memory (NVRAM) 352 and may use direct memory access (DMA) to move packets with minimal overhead and reduce latency. For example, the FPGA 350 may need to store various information, such as information associated with a regular expression engine configured in the FPGA 350. Non-limiting examples of regular expressions that may require memory access include lookahead conditionals, lookbehind conditionals, zero-width expressions, positive lookaheads, positive lookbehinds, grouping constructs, etc. In these examples, aspects of the match may need to be cached in a highly available location due to the limited capacity of the FPGA 350.

The FPGA 350 may also be connected to a volatile random access memory (VRAM) 354 for storing various information, such as configuration files, images, bootstrap environments, etc. The FPGA 350 may also be connected to various sensors 356 for controlling operations of the hardware accelerator 300 (e.g., a temperature sensor, timing controllers, etc.).

In some aspects, the hardware accelerator 300 can be configured to execute specific tasks in parallel without invoking software processing and corresponding delays. In some aspects, the hardware accelerator 300 includes a grid of programmable logic blocks that can be configured to execute specific tasks in parallel. The hardware accelerator 300 is highly efficient for specialized workloads such as cryptography, signal processing, and real-time data processing. In some aspects, the hardware accelerator 300 may outperform a processor for specialized computation processes, such as compression, encryption, and decryption. For example, a general purpose processor may encrypt a TLS packet in microseconds, while the hardware accelerator 300 can do it in nanoseconds by parallelizing encryption operations. At line rate, (e.g., Gbps), software-based TLS decryption and inspection of payload (which is encrypted) is impractical.

In some aspects, the hardware accelerator 300 may be configured for inline inspection of packets at line rate. Packets are generally TLS encrypted and the hardware accelerator 300 can be configured to handle TLS interception to allow inspection of various types of payloads. In addition, the hardware accelerator 300 may be configured to include additional software features such as a regular expression engine for advanced pattern matching for packets at line rate, which also is not possible in software-based processing. In some cases, a regular expression engine in a hardware accelerator 300 can be configured to identify natural language content such as a prompt to a generative response engine or an answer from a generative response engine. In this context, the hardware accelerator 300 can decrypt packets and inspect packets for further evaluation by an AI defense controller (e.g., the defense controller 210 of FIG. 2).

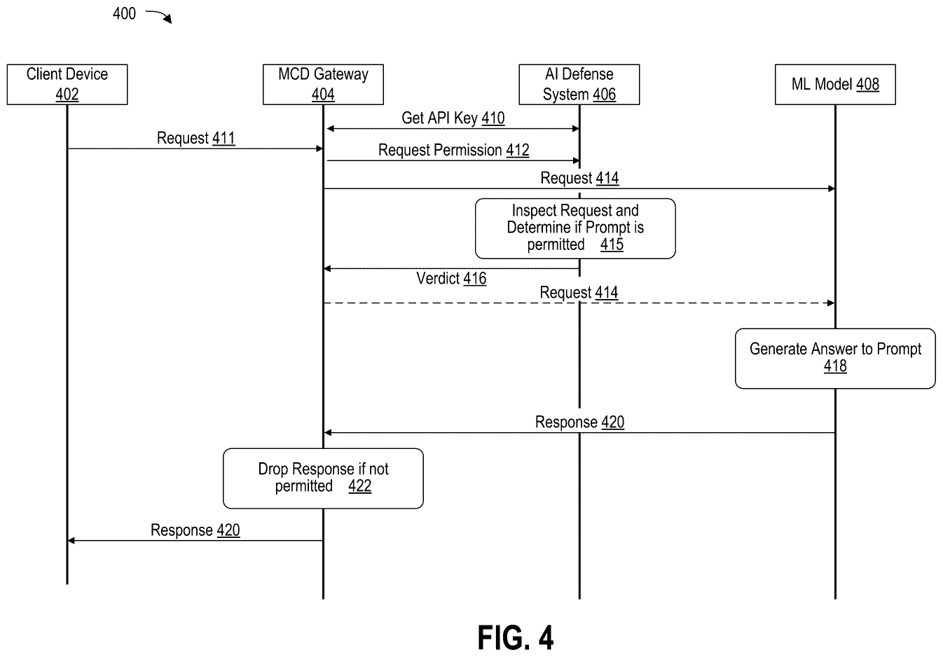

FIG. 4 is a sequence diagram 400 of a multi-cloud application configured to inspect prompts and answers to and from ML models in accordance with some aspects of the disclosure. In some aspects, a client device 402 (e.g., as part of an application on the client device) is configured to send a request 411 to an AI model 408.

The MCD gateway 404 is first configured to retrieve an API key 410 from the AI defense system 406 to validate and secure any responses. Once the API key is retrieved and stored, an MCD gateway 404 is configured to receive the request 411 and proxy the request 411. The MCD gateway 404 may be configured to determine whether the request 411 can be sent to the AI model 408, or an answer from the AI model 408 can be provided to the client device 402. For example, the MCD gateway 404 can decrypt the TLS encryption and inspect a payload (e.g., an HTTP POST payload). In the event the payload has potentially malicious content, the MCD gateway 404 may request permission 412 to send the natural language content in the payload to an AI defense system 406. In some aspects, the aspects MCD gateway 404 is a hardware device (e.g., the hardware accelerator 300 in FIG. 3) that allows inline inspection of payloads at line rate. In some aspects, the MCD gateway 404 may send the request 414 including the natural language content to the AI model 408 to allow asynchronous permission to be determined by the AI defense system 406.

The AI defense system 406 is configured to inspect the request and determine permission for the request 411 at block 415. The AI defense system 406 may also concurrently send the In the event the AI defense system 406 authorizes (e.g., permits) the request at block 415, the AI defense system 406 responds to the permission 412 with a verdict 416 to the MCD gateway 404. In some cases, the MCD gateway 404 may send the request 414 after the verdict 416 is provided by AI defense system 406. However, in this case, the process is synchronous and can incur delays.

At block 418, the AI model 408 generates a response to the prompt in the request 411. In some aspects, the response can include a plurality of responses that are streamed from the AI model 408 over time. For example, the AI model 408 generates a response 420 including a plurality of packets (e.g., server sent events, etc.) that are sent to the client device 402 via the MCD gateway 404.

The MCD gateway 404 receives response 420 and determines whether to drop the response 420 based on the verdict 416 at block 422. For example, if the verdict is to permit the request 411, the MCD gateway 404 sends the response 420 to the client device 402.

In some case, the MCD gateway 404 may be configured to inspect response 420 and determine if the content in the response 420 corresponds to safe and authorized content. In this example, the MCD gateway 404 sends the response 420 to the AI defense system 406 (not shown), which provides permission to the MCD gateway 404 to send the response 420. In this way, the AI defense system 406 is configured to proxy the requests and responses based on permission from a defense controller to prevent unsafe information, leakage of confidential information, and so forth.

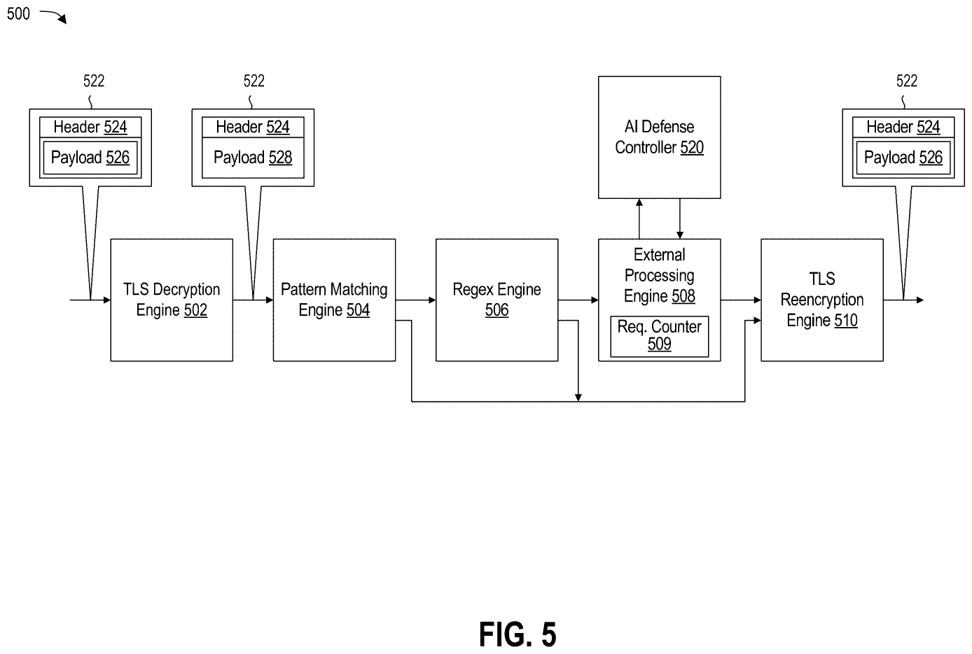

FIG. 5 is a conceptual illustration 500 of a TLS session decryption for inline packet inspection by a hardware accelerator (e.g., the hardware accelerator 300 of FIG. 3) in accordance with some aspects of the disclosure. In some aspects, the hardware accelerator is configured (in hardware) to include a TLS decryption engine 502, a pattern matching engine 504, a regular expression 506, an external processing engine 508, and a TLS encryption engine 510. In some aspects, the external processing engine 508 is configured to invoke external processing, such as using software processing for limited packets. As an example, the external processing engine 508 may be configured to perform AI-based oriented processing to evaluate natural language.

In some aspects, the hardware accelerator is configured to receive a packet 522 that includes a header 524 and an encrypted payload 526 based on a TLS session. In some aspects, the TLS decryption engine 502 is configured to decrypt the payload 526 without ending the TLS session. For example, the TLS decryption engine 502 is configured to act as a man-in-the-middle (MITM) proxy and is able to decrypt the encrypted payload 526 into an unencrypted payload 528.

In some aspects, the TLS decryption engine 502 may perform various types of inspection based on the unencrypted payload 528. For example, the pattern matching engine 504 can perform various pattern matches to ascertain if the packet needs inspections. In one non-limiting example, the pattern matching engine 504 may identify a pattern of alphanumeric characters separated by spaces, potentially indicating that the unencrypted payload 528 includes natural language content. The pattern matching engine 504 can also perform other types of pattern matches, such as identification of particular types of content. In the event that the unencrypted payload 528 does not match any criteria that warrant further inspection (e.g., the unencrypted payload 528 is a Boolean value such as an acknowledgment), the pattern matching engine 504 may provide the unencrypted payload 528 to the TLS encryption engine 510 to reestablish the TLS connection to the destination.

In some aspects, when the pattern matching engine 504 matches one criterion within the unencrypted payload 528 (or the header 524) that warrants further inspection, the pattern matching engine 504 provides the unencrypted payload 528 to the regular expression 506. The regular expression 506 performs a deeper and more complex inspection as compared to the pattern matching engine 504. For example, the regular expression 506 includes various types of regular expression matches that can identify particular types of content with better granularity. The regular expression 506 can be configured to include a regular expression that detects software instructions, natural language prompts, and other types of content. In the event the regular expression 506 matches content that could be malicious, the regular expression 506 may provide the unencrypted payload 528 to the TLS encryption engine 510 to reencrypt and forward the data to the destination.

In the event the regular expression 506 does identify potential malicious content, which would include a benign prompt to an ML model, the regular expression 506 provides the unencrypted payload 528 to the external processing engine 508 for external processing. For example, the regular expression 506 may identify one of a natural language prompt, a model detection event (e.g., the request will trigger another application to invoke a machine learning model), a personally identifiable information event, a vector database event, a classification (e.g., a request to identify a classification of content), and a model event (e.g., a model training event).

In one aspect, the external processing engine 508 may provide the packet to an AI defense controller 520 (e.g., the defense controller 210 of FIG. 2) to analyze the prompt and receive a safety determination. For example, the AI defense controller 520, which is external with respect to the hardware accelerator, may use ML models and various guardrails to identify safety of a prompt and provide a determination to the external processing engine 508 (e.g., safe, unsafe, safe and warn, log, etc.).

In some aspects, the AI defense controller 520 may also include a request counter 509 that identifies outstanding requests and tracks internal state. For example, because the external processing at the AI defense controller 520 has higher latency due to the time domain nature of inference, the request counter 509 may limit the number of requests (e.g., throttle) to the AI defense controller 520. For example, the request counter 509 may limit the number of pending requests to 100 requests per second, 100 requests pending at the AI defense controller 520, etc.). In some aspects, when the request counter 509 is exceeded, the hardware accelerator may respond to the request with an error message to cause the client device to retransmit the packet.

In some aspects, after the external processing engine 508, a stateful inspection of the unencrypted payload 528 can occur. For example, a web application firewall (not shown) can perform stateful inspection across packets and/or flows to identify changes that could be indicative of malicious behavior.

In the event the unencrypted payload 528 is not flagged for malicious content (e.g., determined to be benign by the AI defense controller 520), the external processing engine 508 (or the web application firewall or any other inspection device within the pipeline) provides the unencrypted payload 528 to the TLS encryption engine 510 to reencrypt the data with the destination address and send the TLS decryption engine 502.

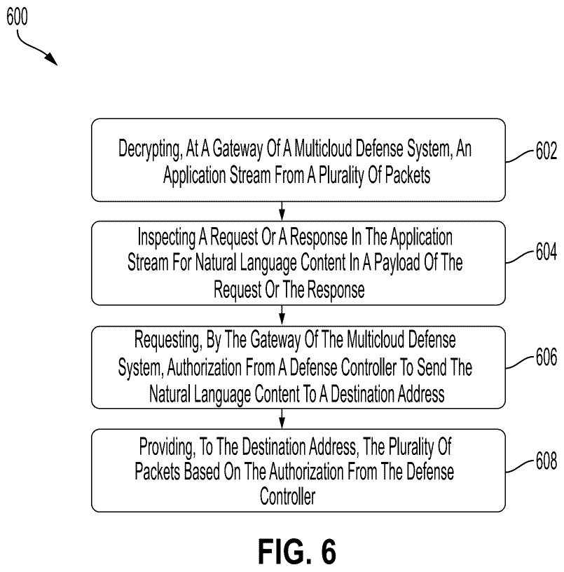

FIG. 6 is a flowchart illustrating an example process 600 for inline inspection of natural language content at a gateway in accordance with some aspects of the disclosure. The process 600 can be performed by a network device, a programmable circuit (e.g. FPGAs), a computing device (or apparatus) or a component (e.g., one or more chipsets, an SoC, one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 600 may be implemented as a configuration that is executed and run on one or more programmable circuits (e.g., FPGAs, etc.). The configuration can be a binary bitstream that causes hardware components to be repurposed and implemented without software interrupts and processing. In some cases, the process 600 may be implemented in an ASIC.

At block 602, the network device may decrypt an application stream from a plurality of packets. In some aspects, the computing device may, as part of block 602, request a hardware accelerator (e.g., in a data center) to decrypt the application stream. For example, the computing device may terminate a TLS session associated with the plurality of packets at the gateway.

In some aspects, the network device executes gateway is controlled by a multi-cloud controller, and the multi-cloud controller is configured to control a plurality of gateways at different cloud provider services.

At block 604, the network device may inspect a request or a response in the application stream for natural language content in a payload of the request or the response.

At block 606, the network device may request authorization from a defense controller to send the natural language content to a destination address. In some aspects, after the authorization from the defense controller, the computing device may perform a stateful inspection at the gateway using an intrusion detection system (e.g., a web application firewall).

In some aspects, the network device (e.g., the gateway) may detect a triggering event in the payload. The triggering event corresponds to one of a natural language prompts, a model detection event, a personally identifiable information event, a vector database event, a classification, and a model event. In response to the triggering event, the computing device may log the triggering event. The logs can be used for service discovery (e.g., the detection of shadow AI applications, various ML/AI services used by other applications, etc.).

At block 608, the network device may provide, to the destination address, the plurality of packets based on the authorization from the defense controller.

In some aspects, the network device may identify a number of concurrent requests to the defense controller and, when the number of concurrent requests is greater than a threshold, send a response to a source address denying a request associated with the application stream. In some aspects, the defense controller may use ML models that have higher latency than conventional requests, and the computing device may throttle requests. In one example, the computing device can return a response indicating that the resource is unavailable, or provide another suitable answer.

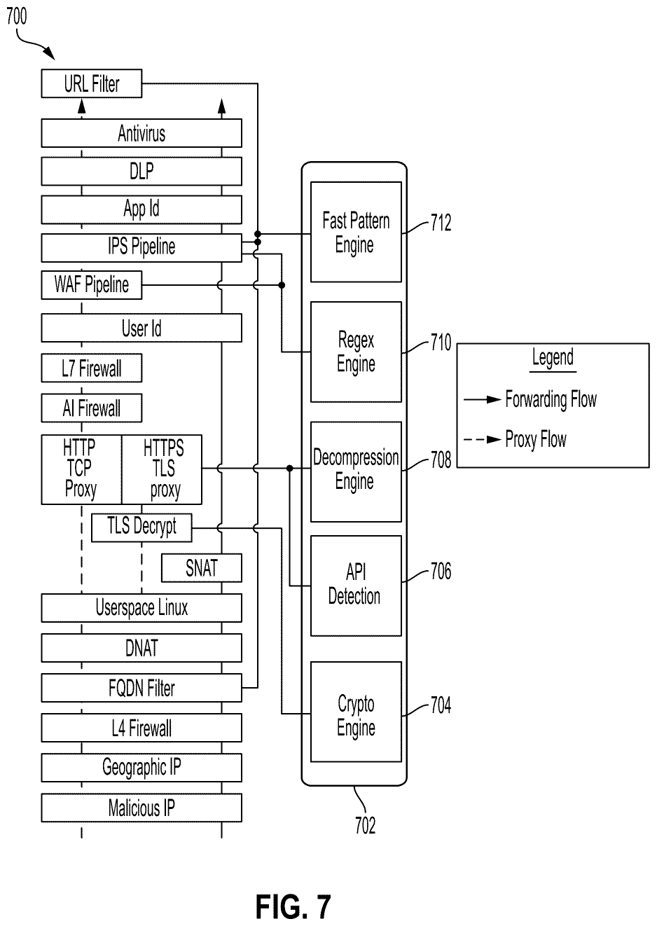

FIG. 7 illustrates a block diagram of a data path pipeline 700 and integration with hardware in accordance with some aspects of the disclosure.

In some aspects, the data path pipeline 700 comprises a single-pass firewall architecture that uses a single-pass flow without expensive context switches and memory copy operations. In a single-pass flow, processing is not duplicated multiple times on a packet. For example, TCP/IP receive and transmission operations are only performed a single time. This is different from existing next-generation firewalls (NGFW). The data path pipeline 700 uses fibers with flexible stages completely running in user-space and, therefore, does not incur a penalty for kernel-user context switches, which are expensive in high bandwidth and low latency operations. The data path pipeline 700 provides advanced web traffic inspection comparable to WAFs to secure all traffic flows and break the attack kill chain in multiple places, raising the economic costs for attackers. The data path pipeline 700 also captures packets of live attacks into a cloud storage bucket without significant performance degradation and enables a rule-based capture on a per-session and attack basis.

The data path pipeline 700 is also configured to be flexible and stages of processing are determined on a per-flow basis. For example, application 1 to application 2 may implement an L4 firewall and IPS inspection, application 3 to application 4 may implement an L4 firewall, a transport layer security (TLS) proxy, and IPS, and an internet client to web application 7implements an L4 firewall, TLS proxy, IPS, and WAF.

In some aspects, the data path pipeline 700 also includes AI firewall functions to handle network flows based on requests and responses from AI and ML models. In some aspects, because the TLS proxy, which terminates a TLS session and decrypts the packet, the AI firewall can request an AI defense controller (e.g., the AI defense controller 110 in FIG. 1) for authorization regarding the request or a response.

In some aspects, the data path pipeline 700 includes various filters (e.g., malicious IP filter), geographic IP filter, fully qualified domain name (FQDN) filter) to filter both forwarding flows and proxy flows, as well as an L4 firewall to restrict traffic based on conventional techniques.

The data path pipeline 700 may also be integrated with a hardware offload 702 (e.g., a field programmable gate arrays (FPGA) of a cloud provider, an application specific integrated circuit (ASIC), etc.) that includes additional functionality that does not impact throughput. In one aspect, a cloud provider may offer a hardware offload or an accelerator function to implement a specialized function. For example, the hardware offload 702 includes a cryptographic engine 704, an API detection engine 706, a decompression engine 708, a regex engine 710, and a fast pattern engine 712 to offload operations into hardware.

In one aspect, the data path pipeline 700 includes high throughput decryption and reencryption to enable inspection of all encrypted flows using the cryptographic engine 704. By contrast, traditional NGFWs provide a throughput of around 10% for inspecting encrypted flows. The data path pipeline 700 may use a decompression engine 708 to decrypt compressed traffic and perform deep packet inspection. For example, the data path pipeline 700 also uses a userspace Linux TCP/IP driver, in addition to network address translation (NAT) in conjunction with the API detection engine 706 and the decompression engine 708 to eliminate problematic and malicious flows.

The data path pipeline 700 includes a transparent reverse and forward proxy to isolate clients and servers without exposing internal details, a layer 7 firewall to rate limit and protect applications and APIs, and secure user access by looking up end-user-specific identity from an identity provider (IDP) and provide zero trust network access (ZTNA). The data path pipeline 700 includes a WAF pipeline and an IPS pipeline to detect malicious and problematic flows in conjunction with a regex engine 710 and a fast pattern engine 712. For example, the WAF pipeline may implement protection for web applications, including OWASP Top 10,using a core ruleset and application-specific rules for frameworks and common content management tools like PHP, Joomla, and WordPress. The data path pipeline 700 includes IDS and IPS to block known vulnerabilities and provide virtual patching until the applications can be patched with updated security fixes, application identification to block traffic based on client, server or application payload, DLP loss and filtering, URI filtering, antivirus and anti-malware features to prevent malware files from being transferred for ingress (malicious file uploads), east-west lateral attacks (moving toolkits) and egress flows (e.g., botnets).

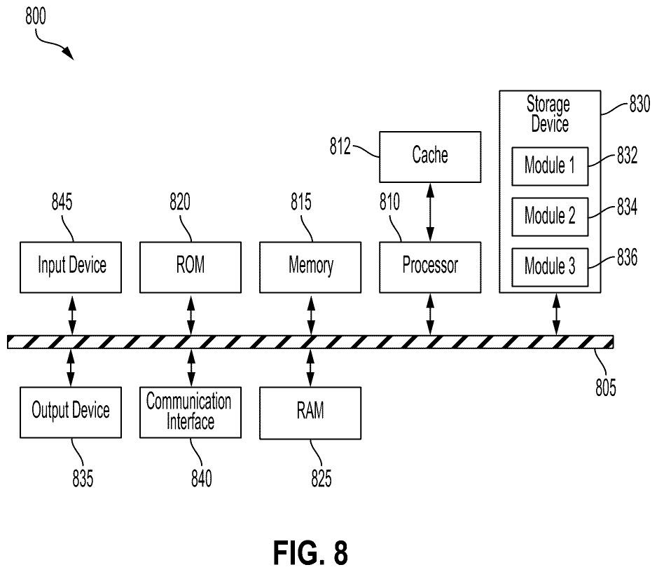

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some embodiments, computing system 800 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 800 includes at least one processing unit (CPU or processor) 810 and connection 805 that communicatively couples various system components including system memory 815, such as ROM 820 and RAM 825 to processor 810. Computing system 800 may include a cache 812 of high-speed memory connected directly with, in close proximity to, or integrated as part of processor 810.

Processor 810 may include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some embodiments, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (<) and greater than (>) symbols or terminology used herein may be replaced with less than or equal to (“≤”) and greater than or equal to (“≥”)symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A computing device for performing a function. The computing device includes at least one memory and at least one processor coupled to the at least one memory and configured to: decrypting, at a gateway of a multicloud defense system, an application stream from a plurality of packets; inspecting a request or a response in the application stream for natural language content in a payload of the request or the response; requesting, by the gateway of the multicloud defense system, authorization from a defense controller to send the natural language content to a destination address; and providing, to the destination address, the plurality of packets based on the authorization from the defense system.
Aspect 2. The computing device of Aspect 1, wherein the at least one processor is configured to: decrypt a payload of aa transport layer security (TLS) session at the gateway.
Aspect 3. The computing device of any of Aspects 1 to 2, wherein the at least one processor is configured to: after the authorization from the defense system, reencrypting the payload to continue the TLS session from the gateway to the destination address.
Aspect 4. The computing device of any of Aspects 1 to 3, wherein the at least one processor is configured to: after the authorization from the defense system, performing a stateful inspection at the gateway using an intrusion detection system.
Aspect 5. The computing device of any of Aspects 1 to 4, wherein the at least one processor is configured to: wherein the gateway is controlled by a multicloud controller configured to control a plurality of gateways at different cloud provider services.
Aspect 6. The computing device of any of Aspects 1 to 5, wherein the at least one processor is configured to: detecting a triggering event in the payload, wherein the triggering event corresponds to one of a natural language prompt, a model detection event, a personally identifiable information event, a vector database event, a classification, a model event; and logging the triggering event.
Aspect 7. The computing device of any of Aspects 1 to 6, wherein the at least one processor is configured to: identifying a number of concurrent requests to the defense system; and when the number of concurrent requests is greater than a threshold, sending a response to a source address denying a request associated with the application stream.
Aspect 8. A network device for configured in a multicloud defense system for inspecting packets at line rate. The network device includes at least one memory and at least one processor coupled to the at least one memory and configured to: decrypting, at a gateway of a multicloud defense system, an application stream from a plurality of packets; inspecting a request or a response in the application stream for natural language content in a payload of the request or the response; requesting, by the gateway of the multicloud defense system, authorization from a defense system to send the natural language content to a destination address; and providing, to the destination address, the plurality of packets based on the authorization from the defense system.
Aspect 9. The network device of Aspect 8, wherein the at least one processor is configured to: decrypting a payload associated with a transport layer security (TLS) session at the gateway.
Aspect 10. The network device of any of Aspects 8 to 9, wherein the at least one processor is configured to: after the authorization from the defense system, reencrypt the payload to continue the TLS session from the gateway to the destination address.
Aspect 11. The network device of any of Aspects 8 to 10, wherein the at least one processor is configured to: after the authorization from the defense system, performing a stateful inspection at the gateway using an intrusion detection system.
Aspect 12. The network device of any of Aspects 8 to 11, wherein the at least one processor is configured to: wherein the gateway is controlled by a multicloud controller configured to control a plurality of gateways at different cloud provider services.
Aspect 13. The network device of any of Aspects 8 to 12, wherein the at least one processor is configured to: detecting a triggering event in the payload, wherein the triggering event corresponds to one of a natural language prompt, a model detection event, a personally identifiable information event, a vector database event, a classification, a model event; and logging the triggering event.
Aspect 14. The network device of any of Aspects 8 to 13, wherein the at least one processor is configured to: identifying a number of concurrent requests to the defense system; and when the number of concurrent requests is greater than a threshold, sending a response to a source address denying a request associated with the application stream.
Aspect 15. A non-transitory programmable hardware device configuration comprising a bitstream that configure a programmable circuit to: decrypt an application stream from a plurality of packets; inspect a request or a response in the application stream for natural language content in a payload of the request or the response; request authorization from a defense system to send the natural language content to a destination address; and provide, to the destination address, the plurality of packets based on the authorization from the defense system.
Aspect 16. The programmable hardware device configuration of Aspect 15, wherein the bitstream configures the programmable circuit to: decrypt a payload in a transport layer security (TLS) session at the gateway.
Aspect 17. The programmable hardware device configuration of any of Aspects 15 to 16, wherein the bitstream configures the programmable circuit to: after the authorization from the defense system, reencrypt the payload to continue the TLS session from the gateway to the destination address.
Aspect 18. The programmable hardware device configuration of any of Aspects 15 to 17, wherein the bitstream configures the programmable circuit to: after the authorization from the defense system, performing a stateful inspection at the gateway using an intrusion detection system.
Aspect 19. The programmable hardware device configuration of any of Aspects 15 to 18, wherein the bitstream configures the programmable circuit to: detecting a triggering event in the payload, wherein the triggering event corresponds to one of a natural language prompt, a model detection event, a personally identifiable information event, a vector database event, a classification, a model event; and logging the triggering event.
Aspect 20. The programmable hardware device configuration of any of Aspects 15 to 19, wherein the bitstream configures the programmable circuit to: detect a triggering event in the payload, wherein the triggering event corresponds to one of a natural language prompt, a model detection event, a personally identifiable information event, a vector database event, a classification, a model event; and log the triggering event

What is claimed is:

1. A method comprising:
decrypting, at a gateway of a multicloud defense system, an application stream from a plurality of packets;
inspecting a request or a response in the application stream for natural language content in a payload of the request or the response;
requesting, by the gateway of the multicloud defense system, authorization from a defense system to send the natural language content to a destination address; and
providing, to the destination address, the plurality of packets based on the authorization from the defense system.

2. The method of claim 1, further comprising:
decrypting a payload associated with a transport layer security (TLS) session at the gateway.

3. The method of claim 1, further comprising:
after the authorization from the defense system, reencrypting the payload to continue the TLS session from the gateway to the destination address.

4. The method of claim 1, further comprising:
after the authorization from the defense system, performing a stateful inspection at the gateway using an intrusion detection system.

5. The method of claim 1, wherein the gateway is controlled by a multicloud controller configured to control a plurality of gateways at different cloud provider services.

6. The method of claim 1, further comprising:
detecting a triggering event in the payload, wherein the triggering event corresponds to one of a natural language prompt, a model detection event, a personally identifiable information event, a vector database event, a classification, a model event; and
logging the triggering event.

7. The method of claim 1, further comprising:
identifying a number of concurrent requests to the defense system; and
when the number of concurrent requests is greater than a threshold, sending a response to a source address denying a request associated with the application stream.

8. A network device configured in a multicloud defense system for inspecting packets at line rate, comprising:
at least one memory; and
at least one programmable hardware circuit configured to:
decrypt an application stream from a plurality of packets;
inspect a request or a response in the application stream for natural language content in a payload of the request or the response;
request authorization from a defense system to send the natural language content to a destination address; and
provide, to the destination address, the plurality of packets based on the authorization from the defense system.

9. The network device of claim 8, wherein the at least one programmable hardware circuit is configured to:
decrypt a payload associated with a transport layer security (TLS) session at the network device.

10. The network device of claim 8, wherein the at least one programmable hardware circuit is configured to:
after the authorization from the defense system, reencrypt the payload to continue the TLS session to the destination address.

11. The network device of claim 8, wherein the at least one programmable hardware circuit is configured to:
after the authorization from the defense system, perform a stateful inspection using an intrusion detection system.

12. The network device of claim 8, wherein the network device is controlled by a multicloud controller configured to control a plurality of gateways at different cloud provider services.

13. The network device of claim 8, wherein the at least one programmable hardware circuit is configured to:
detect a triggering event in the payload, wherein the triggering event corresponds to one of a natural language prompt, a model detection event, a personally identifiable information event, a vector database event, a classification, a model event; and
log the triggering event.

14. The network device of claim 8, wherein the at least one programmable hardware circuit is configured to:
identify a number of concurrent requests to the defense system; and
when the number of concurrent requests is greater than a threshold, send a response to a source address denying a request associated with the application stream.

15. A non-transitory programmable hardware device configuration comprising a bitstream that configure a programmable circuit to:
decrypt an application stream from a plurality of packets;
inspect a request or a response in the application stream for natural language content in a payload of the request or the response;
request authorization from a defense system to send the natural language content to a destination address; and
provide, to the destination address, the plurality of packets based on the authorization from the defense system.

16. The programmable hardware device configuration of claim 15, wherein the bitstream configures the programmable circuit to: decrypt a payload in a transport layer security (TLS) session.

17. The programmable hardware device configuration of claim 15, wherein the bitstream configures the programmable circuit to: after the authorization from the defense system, reencrypt the payload to continue the TLS session to the destination address.

18. The programmable hardware device configuration of claim 15, wherein, after the authorization from the defense system, a stateful inspection of the payload is performed using an intrusion detection system.

19. The programmable hardware device configuration of claim 15, wherein the bitstream configures the programmable circuit to:
detect a triggering event in the payload, wherein the triggering event corresponds to one of a natural language prompt, a model detection event, a personally identifiable information event, a vector database event, a classification, a model event; and
log the triggering event.

20. The programmable hardware device configuration of claim 15, wherein the bitstream configures the programmable circuit to:
identify a number of concurrent requests to the defense system; and
when the number of concurrent requests is greater than a threshold, send a response to a source address denying a request associated with the application stream.
